(19) United States
(12) Patent Application Publication
(10) Pub. No.: US 2018/0093714 A1
(43) Pub. Date: Apr. 5, 2018

(54) DRAG REDUCING DEVICE OF CAR

(71) Applicant: Smart Energy Inc., Tainan City (TW)

(72) Inventor: Shih-Hsiung CHEN, Tainan City (TW)

(21) Appl. No.: 15/286,155

(22) Filed: Oct. 5, 2016

(51) Int. Cl. B62D 35/00

(52) U.S. Cl. CPC B62D 35/001; B62D 35/007

(57) ABSTRACT

A drag reducing device of car is installed on rear of a car. The drag reducing device of car includes a frame, the frame includes at least an outer spoiler and an inner spoiler, the outer spoiler and the inner spoiler are arranged at interval and an air flow channel is defined between the outer spoiler and the inner spoiler, an air inlet and a wind outlet are respectively defined on the frame and at two ends of the air flow channel, and a ratio of the wind outlet to the air inlet is defined within a range of 1.2 to 2.5. Thereby, energy efficiency and stability of cruise are increased.

### BACKGROUND OF THE INVENTION

### Technical Field

The present disclosure is related to a structure for reducing wind drag, particularly a car drag reducing device.

### Description of Related Art

According to FIG. 1, a conventional car is affected by surrounding air flow while moving and therefore energy inefficient. A car container 10 of a conventional freight carrier is generally of a rectangular shape, and a wide leeward side is formed at rear of the car container 10. A wide negative pressure zone is caused by the a huge vortex in the leeward side while the cat is moving, a wide high pressure zone is formed in a windward side at front of the car, and a strong wind drag is caused by a pressure difference between the high pressure zone and the negative pressure zone. In particular, a large vehicle is larger than a small car, the wind drag results in additional energy cost in long time and long distance cruise, and causes further burden of transport operators. In order to reduce wind drag, arranging a spoiler 20 at rear of the car container 10 to guide air flow passing through lateral surfaces of the car container 10 into the negative pressure zone at rear of the car container 10 is a conventional solution, the vortex is thereby weakened to pressure the negative pressure zone and further reduce pressure difference between the high pressure zone and the negative pressure zone. However, the spoiler 20 is mainly used for deflecting the air flow and causes ineffective inference on reducing pressure difference.

In views of this, in order to solve the above disadvantage, the present inventor studied related technology and provided a reasonable and effective solution in the present disclosure.

### SUMMARY

The present disclosure provided a drag reducing device of car for a big car.

The present disclosure provided a drag reducing device of car installed on rear of a car container, the drag reducing device of car includes a frame, the frame includes at least an outer spoiler and an inner spoiler, the outer spoiler and the inner spoiler are arranged at interval and an air flow channel is defined between the outer spoiler and the inner spoiler, an air inlet and a wind outlet are respectively defined on the frame and at two ends of the air flow channel, a ratio of the wind outlet to the air inlet is defined within a range of 1.2 to 2.5.

The drag reducing device of car of the present disclosure, wherein, a couple of connecting plates is connected between the outer spoiler and the inner spoiler. The outer spoiler and the inner spoiler are curved plate, the outer spoiler is bent toward the inner spoiler and the outer spoiler and the inner spoiler are bent toward the same side. A curvature of the outer spoiler is larger than a curvature of the inner spoiler. A bent angle of the outer spoiler is defined within a range of 15 degrees to 60 degrees. The outer spoiler, the inner spoiler and the connecting plates are one-piece-formed.

The drag reducing device of car of the present disclosure, wherein, the frame further includes at least a partition plate contained in the air flow channel, and partition plate and the connecting plates are arranged parallel with each other and at interval.

The drag reducing device of car of the present disclosure further includes a couple of connecting components, and the couple of connecting components are respectively fixed on the car container and connected with the frame. Each of the connecting components includes an L-shape angle iron fixed on the car container, and a shaft having an end fixed on the frame and the other end pivotally connected with the L-shape angle iron. Each of the connecting components includes an L-shape angle iron fixed on the car container, a screw rod having an end fixed on the frame and the other end inserted through the L-shape angle iron, and a fixing element used for fastening corresponding screw rod screw connected.

The drag reducing device of car of the present disclosure, wherein, a ratio of the wind outlet to the air inlet is defined within a range of 1.4 to 2.0.

The drag reducing device of car of the present disclosure air flow is pressured by area change between the air inlet and the wind outlet, and further injected into a negative pressure zone at leeward side of rear of the car container, and energy efficiency and stability of cruise are thereby increased.

### BRIEF DESCRIPTION OF DRAWING

The present disclosure can be more fully understood by reading the following detailed description of the embodiment, with reference made to the accompanying drawings as follows:

FIG. 1 is a perspective view showing a conventional drag reducing device.

FIG. 2 is a schematic view showing a drag reducing device of car in an embodiment of the present disclosure.

FIG. 3 is a sectional view showing the drag reducing device of car in the embodiment of the present disclosure.

FIGS. 4 to 8 are perspective views showing an arrangement of the drag reducing device of car in the embodiment of the present disclosure.

FIG. 9 is a perspective view showing the drag reducing device of car under operation in the embodiment of the present disclosure.

FIGS. 10 to 11 are perspective views showing another arrangement of the drag reducing device of car in the embodiment of the present disclosure.

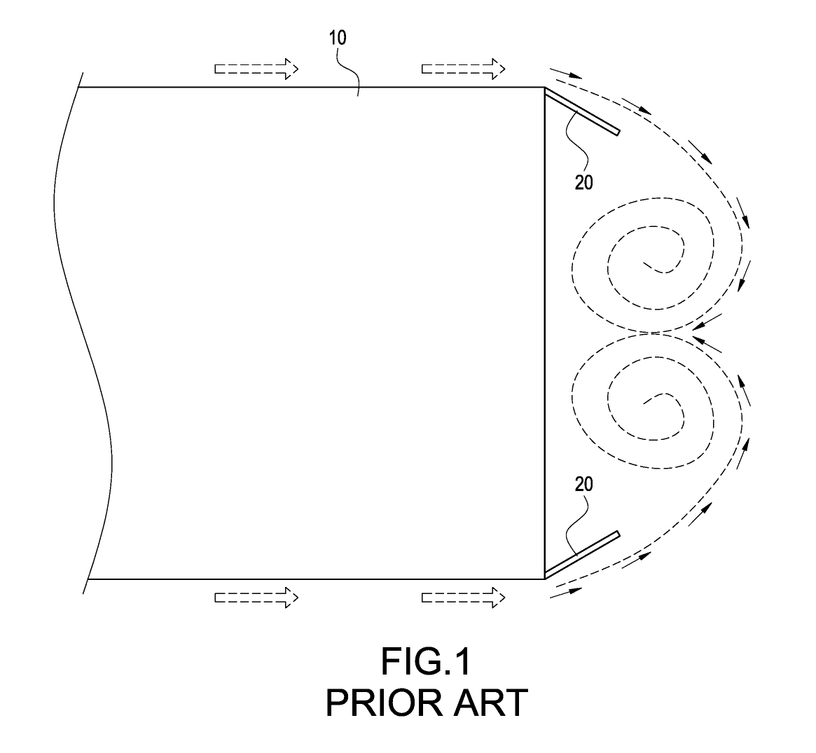

### DETAILED DESCRIPTION

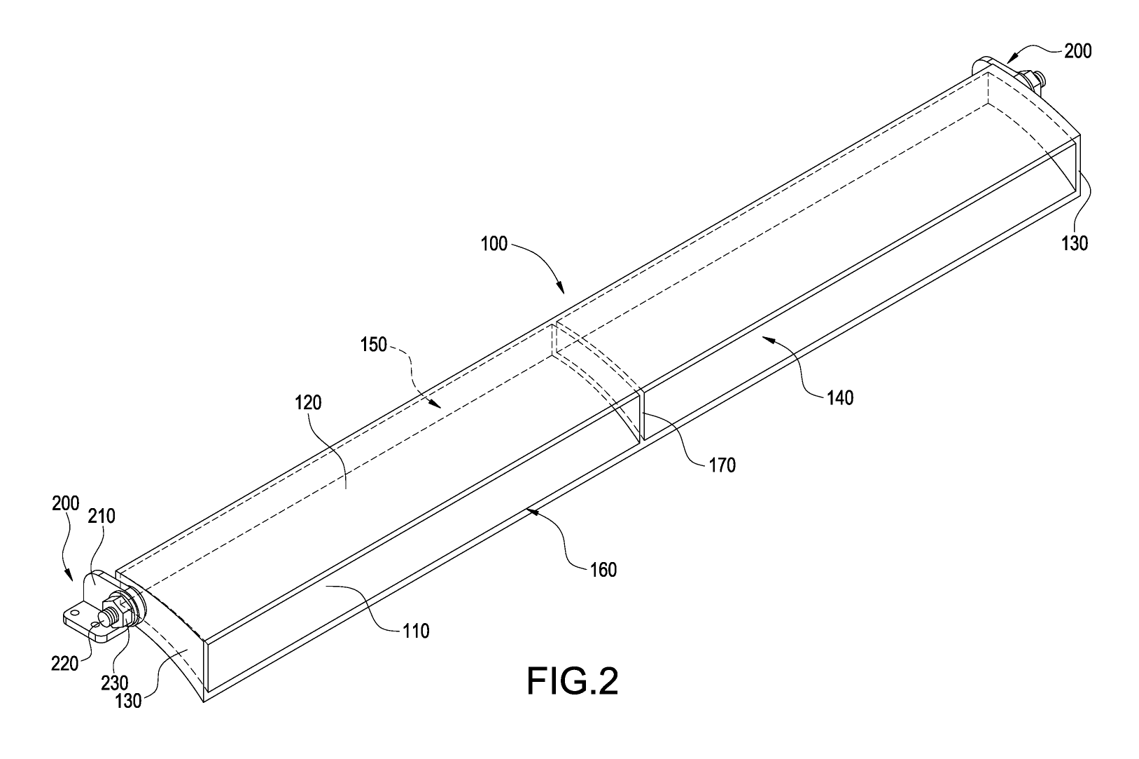

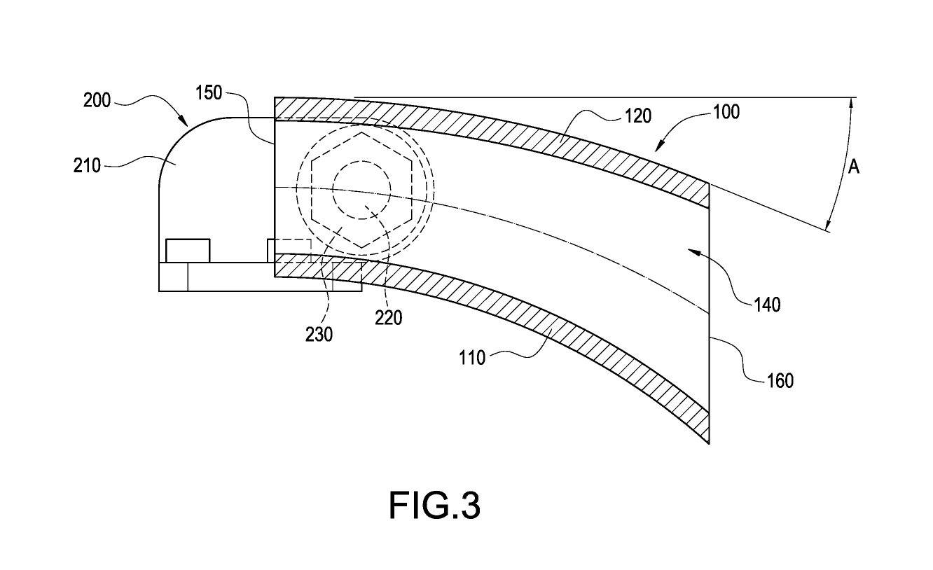

Please refer to FIGS. 2 and 3, a drag reducing device of car mainly including a frame 100 and a couple of connecting component 200 is provided in an embodiment of the present disclosure.

The frame 100 includes an outer spoiler 110, an inner spoiler 120 and two connecting plates 130 one-piece formed, the outer spoiler 110 and the inner spoiler 120 are of curved shapes, and the two connecting plates 130 are respectively connected between respective curve edges of the outer spoiler 110 and the inner spoiler 120between, the outer spoiler 110and the inner spoiler 120 are thereby arranged at interval and an air flow channel 140 is defined therebetween. Otherwise, an air inlet 150 and a wind outlet 160 are defined on the frame 100 and respectively at a front end and a rear end of the air flow channel 140. The outer spoiler 110 is bent toward the inner spoiler 120 and the outer spoiler 110 and the inner spoiler 120 are bent toward the same side, a curvature of the outer spoiler 110 is larger than a curvature of the inner spoiler 120 (according to FIG. 3), an area defined by the wind outlet 160 is thereby larger than another area defined by the air inlet 150, and a ratio of the area of the wind outlet 160 the area of the air inlet 150 ratio is defined within a range of 1.2 to 2.5 and preferably within a range of 1.4 to 2.0. A bent angle A of the outer spoiler is defined within a range of 15 degrees to 60 degrees.

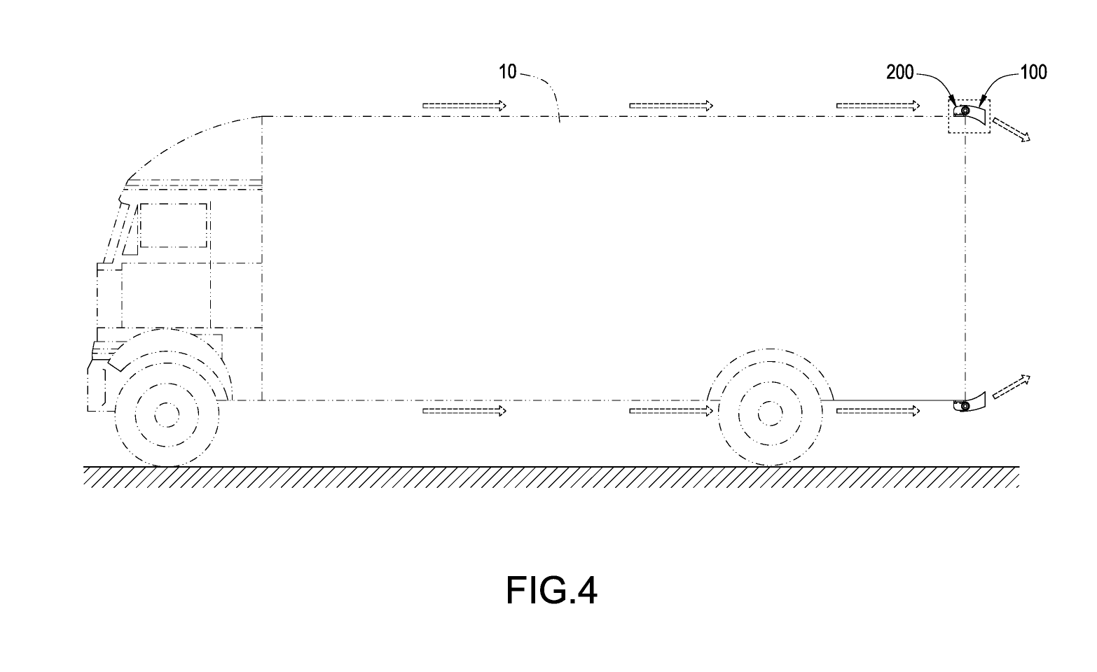

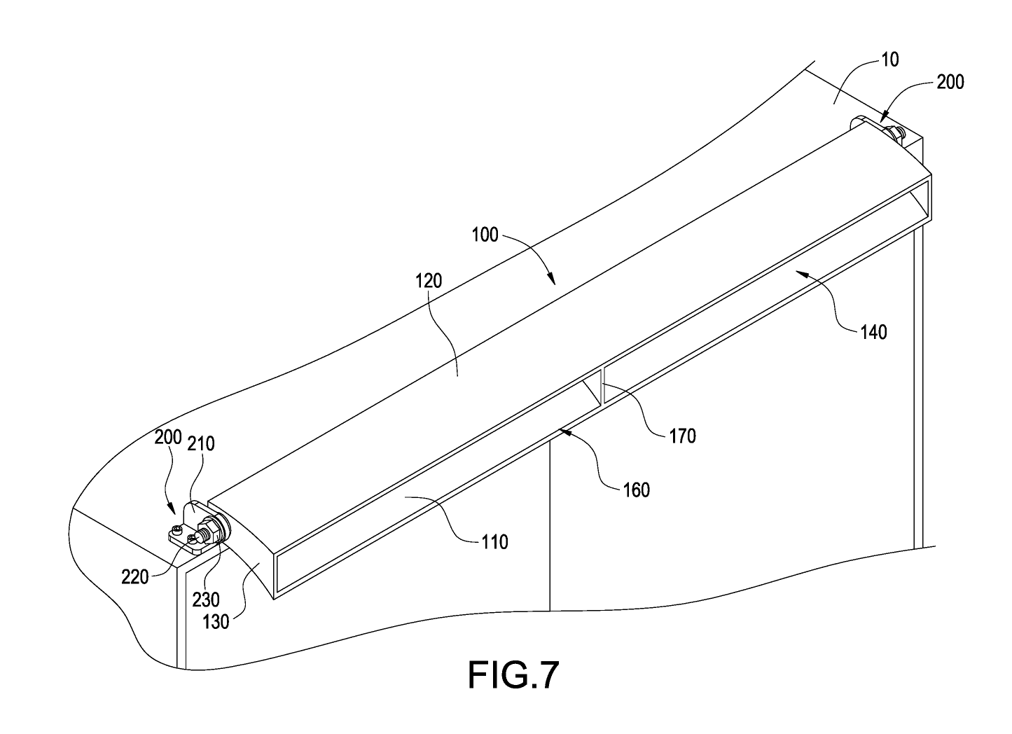

Please refer to FIGS. 4 to 7, the connecting component 200 main includes an L-shape angle iron 210, a shaft 220 and a fixing element 230, a through (not shown in Figs.) for inserting the shaft 220 therein is defined on the L-shape angle iron 210. The shaft 220 of the present embodiment is a screw rod, an end thereof is inserted in aforementioned connecting plate 130 and thereby fix connected. The fixing element 230 in the present embodiment is a nut used for screw fastening corresponding shaft 220, and thereby clamping the L-shape angle iron 210 at a front end of aforementioned connecting plate 130.

Please refer to FIGS. 2, 6 and 7, the frame 100 of the present disclosure could further includes at least a partition plate 170 arranged in and separating the air flow channel 140 and arranged parallel with aforementioned connecting plate 130, and resistance of deformation of the outer spoiler 110 and the inner spoiler 120 are thereby reinforced.

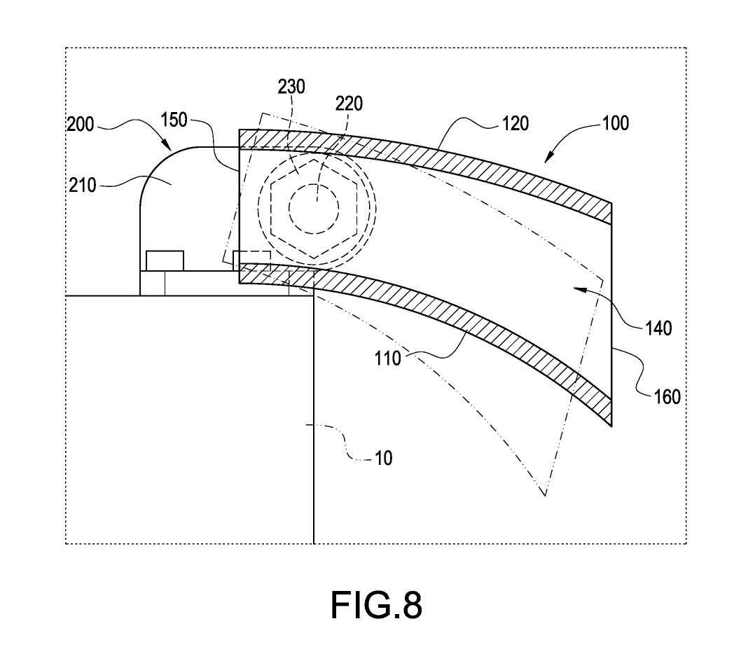

Please refer to FIG. 8, the drag reducing device of car of the present disclosure, wherein the frame 100 is pivotally connected with the connecting component 200. Therefore, the frame 100 could be up-down swung related to the connecting component 200 about the shaft 220, corresponding to variably types of car container 10.

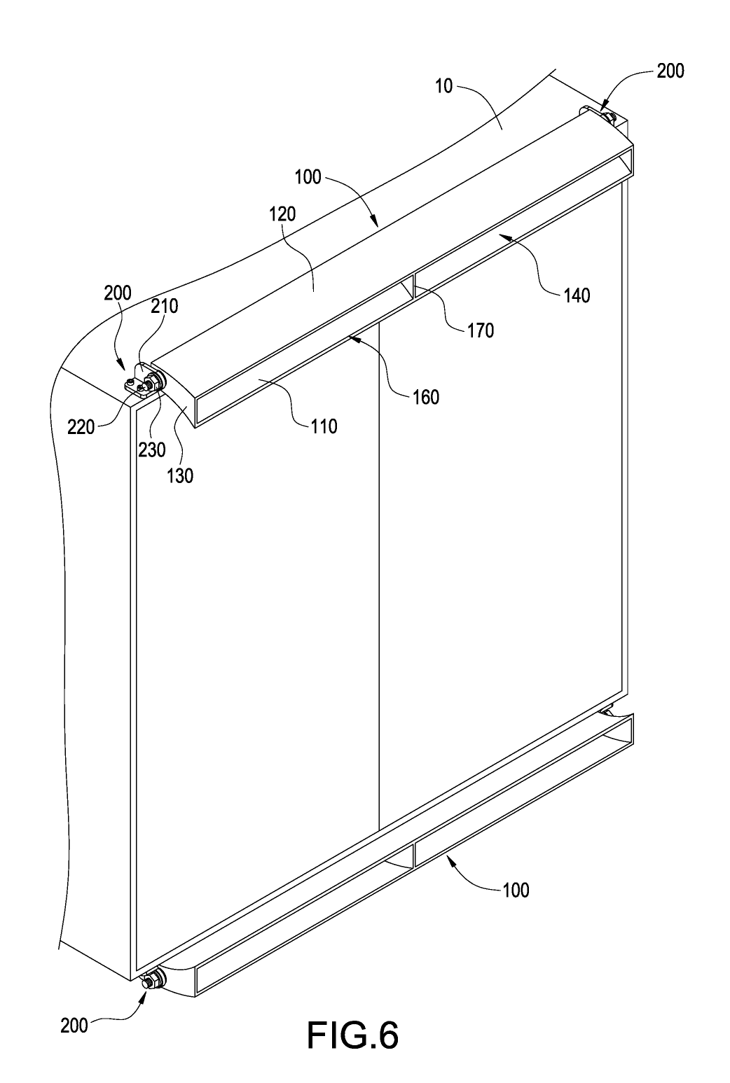

Please refer to FIG. 6, in the present embodiment, a couple of the drag reducing devices of car of the present disclosure is preferably installed on upper and lower sides of rear of a car container 10 of a truck or a freight carrier, predetermined screw hole(s) (not shown in Figs.) is (are) defined on the car container 10, and the frame 100 is installed on the car container 10 by screw connecting members such as screw bolt inserted through the L-shape angle iron 210.

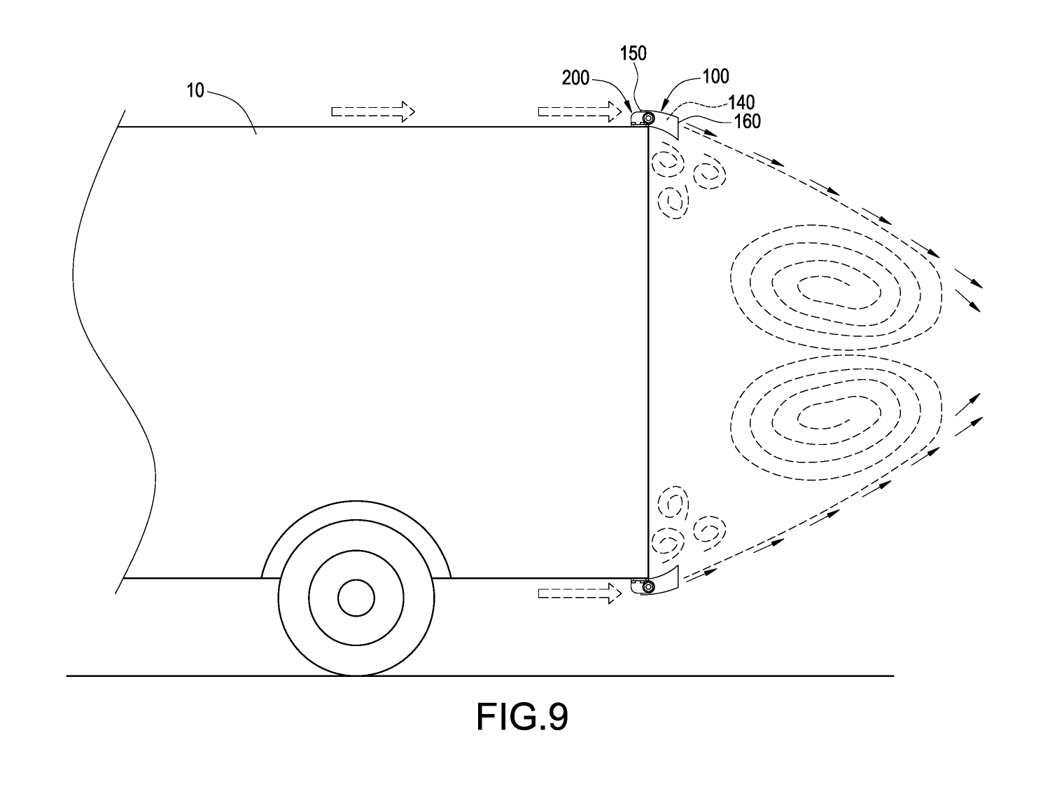

Please refer to FIGS. 4, 5 and 9, while the car is moving, the air flow flows from windward side and passes through lateral surfaces of the car container 10 (indicated by arrows). Air flow flows into the frame 100 through the air inlet 150 at a front end of the frame 100 while arrives rear of the car container 10. The air flow is guided to flow along the air flow channel 140 in the frame 100 and flow out through the wind outlet 160. The area defined by the wind outlet 160 is larger than the area defined by the air inlet 150, the air flow is thereby slowed down and pressured in the air flow channel 140 of the frame 100 (according to Bernoulli's principle). Therefore, pressure of the air flow at the wind outlet 160 is increased, the air flow flows through the air flow channel 140 of the frame 100 more easily while flows into the low pressure vortex zone at rear of the car container 10, and pressure loss of out flow is less. Moreover, shrink of the vortex zone at rear of the car container 10 is result from the higher pressure air flow, deflected air flow and higher air flux, and pressure at leeward side at rear of the car container 10 is increased (according to Description of Related Art, a low pressure drag load on rear of the car container 10 is mainly caused by low pressure at leeward side thereof, and the car is thereby pushed backward). Therefore, the wind drag of the car container 10 is reduced and energy efficiency of cruise is increased.

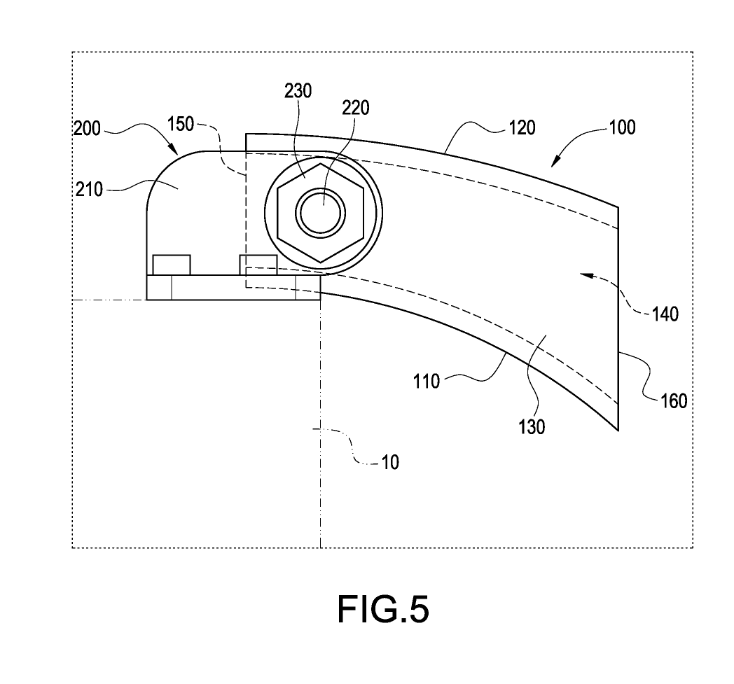

Please refer to FIGS. 3 and 5, accordingly, the air flow flowing through the channel 140 is pressed, the air flow passing through lateral surfaces of the car container 10 and bypassing the air flow channel 140 is not pressed, outer deflection of the air flow flowing through air flow channel 140 caused by inordinate pressure difference between two adjacent air flows breaks flow field and fails to reduce wind drag. Secondly, according to fluid mechanics, a rapid expansion of air flow in a channel results in separation vortex on inner wall of the channel, the separation vortex causes influences on increasing of flow velocity and pressure, and flow efficiency is therefore decreased. Therefore, in the present disclosure, a ratio of the area of the wind outlet 160 to the area of the air inlet 150 is defined within a range of 1.2 to 2.5 and preferably within a range of 1.4 to 2.0.

An inordinate attack angle related to the outer spoiler 110 is formed in the air flow passing through lateral surfaces of the car container 10 while the air flow is rapidly deflecting in the channel 140, a higher pressure zone is formed at inner side of this outer spoiler 110 and a lower pressure zone is formed at outer side thereof, and an additional inordinate drag is therefore caused and efficiency of reducing drag at rear of the car container 10 is decreased. Therefore, in the present disclosure, the bent angle A of the outer spoiler 110 is preferably within a range of 15 degrees to 60 degrees.

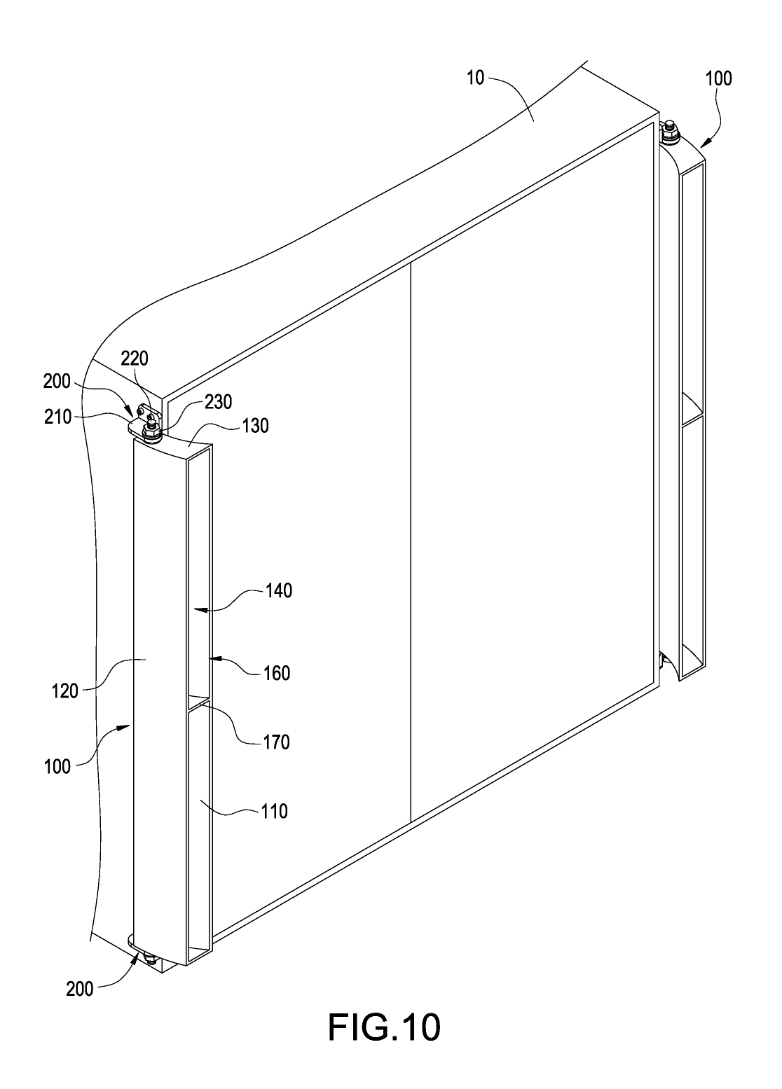

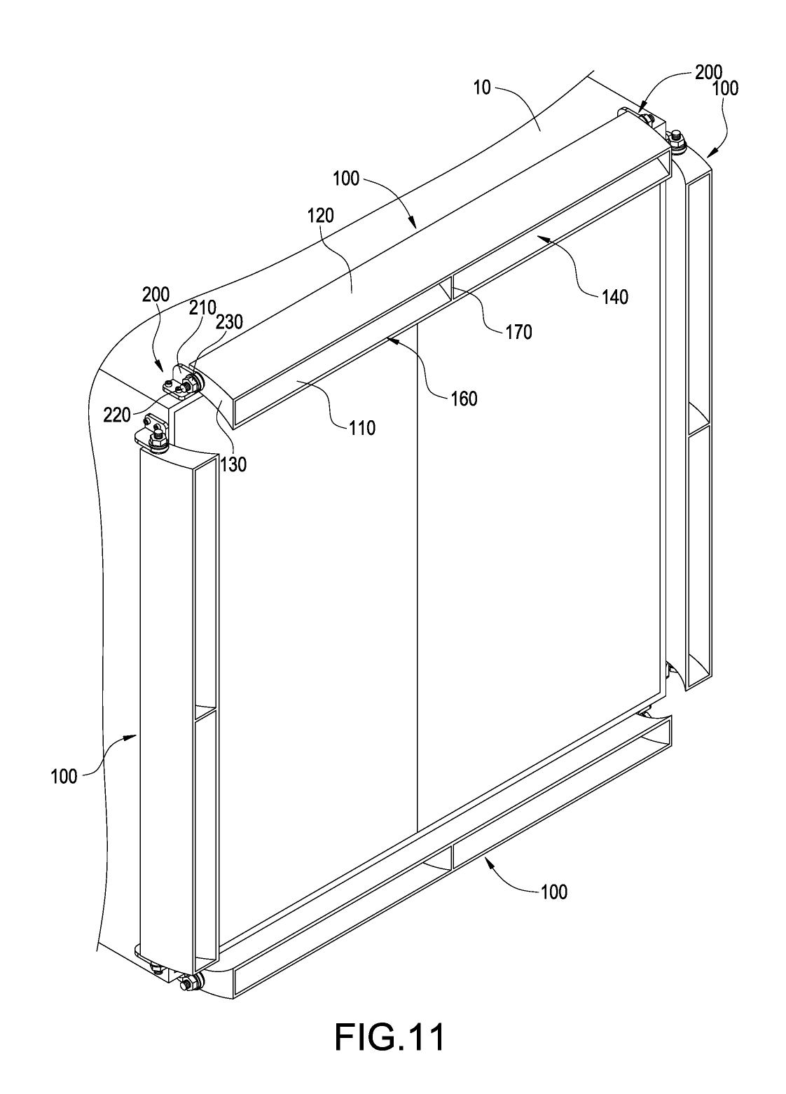

Please refer to FIGS. 10 and 11, the drag reducing device of car could be arranged at various locations according to various requirement and types of car, for example, both of left and right sides of rear of the car container 10 according to FIG. 10. Perhaps, drag reducing devices are arranged at each of upper, lower, left and right sides of rear of car container 10 according to FIG. 11. Thereby, wind drag caused at each side is reduced.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within a range of the scope of the present disclosure as defined in the appended claims.

1. A car drag reducing device installed at rear of a car container, the car drag reducing device comprising a frame, the frame comprising at least an outer spoiler and an inner spoiler, the outer spoiler and the inner spoiler being arranged at interval and an air flow channel being defined between the outer spoiler and the inner spoiler, an air inlet and a wind outlet are respectively defined on the frame and at two ends of the air flow channel, a ratio of the wind outlet to the air inlet being within a range of 1.2 to 2.5,
wherein a couple of connecting plates is connected between the outer spoiler and the inner spoiler;
wherein the outer spoiler and the inner spoiler are curved plate, the outer spoiler is bent toward the inner spoiler and the outer spoiler and the inner spoiler are bent toward the same side;
wherein a curvature of the outer spoiler is larger than a curvature of the inner spoiler; and
wherein a bent angle of the outer spoiler is defined within a range of 15 degrees to 60 degrees to reduce drag caused by pressure difference between an inner side and an outer side of the outer spoiler.

2-5. (canceled)

6. The car drag reducing device according to claim 1, wherein the outer spoiler, the inner spoiler and the connecting plates are one-piece-formed.

7. The car drag reducing device according to claim 1, wherein the frame further comprises at least a partition plate contained in the air flow channel, and the partition plate and the connecting plates are arranged parallel with each other and at interval.

8. The car drag reducing device according to claim 1, further comprising a couple of connecting components, the couple of connecting components are respectively fixed on the car container and connected with the frame.

9. The car drag reducing device according to claim 8, wherein each of the connecting components comprises an L-shape angle iron fixed on the car container, and a shaft having an end fixed with the frame and the other end pivotally connected with the L-shape angle iron.

10. The car drag reducing device according to claim 8, wherein each of the connecting component comprises an L-shape angle iron fixed on the car container, a screw rod having an end fixed with the frame and the other end inserted through the L-shape angle iron, and a fixing element used for fastening corresponding screw rod screw connected.

11. (canceled)
